(19) United States
(12) Patent Application Publication
(10) Pub. No.: US 2009/0327967 A1
(43) Pub. Date: Dec. 31, 2009

(54) ENGINEERING TOOL

(75) Inventors: Osamu Matsuda, Hitachinaka (JP); Toru Akatsu, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/491,580

(22) Filed: Jun. 25, 2009

(30) Foreign Application Priority Data
Jun. 26, 2008 (JP) 2008-167587

(51) Int. Cl. G06F 3/048

(52) U.S. Cl. 715/840

(57) ABSTRACT

In an engineering tool, the control logic is divided into the plurality of logic sheets to be edited, a connection having sheet connection information for defining a connection relationship between the logic sheets is described on the logic sheet, and the control logic is displayed on the display screen of a display device so as to begin a new page of the logic sheets of the control logic in units of the logic sheet in the control logic. In the engineering tool, a button function operable on the display screen is provided to a button function. When the connection is operated with a pointer, one of the logic sheets defined by the sheet connection information possessed by the operated connection is used as a new-page candidate, and a reduced list of the logic sheets of the new-page candidates is displayed on the display screen.

### BACKGROUND OF THE INVENTION

The present invention relates to engineering tool and more particularly, to an engineering tool which is suitably used, for example, for plant control or the like in an thermal power plant.

An engineering tool functions to support creation of a control program used in a controller of a plant or the like, or functions to support online monitoring of a control state under control of the control program (for example, see JP-A-2003-67007).

The program creation support by the engineering tool is achieved by creating a control program through the conversion of a control logic edited by a user with use of various types of function macros (which are also called function boxes) and input and output lines indicative of input and output in such function macros. With respect to the editing of the control logic in this case, description contents in the control logic can be usually divided and described into a plurality of logic sheets. In other words, a plurality of logic sheets usually forms a single control logic, and a connection relationship between the respective logic sheets in the control logic is defined by a connection. That is, a connection can be described in association with input and output lines of an function macro in the logic sheet, and the connection can take a role of having sheet connection information for defining the connection relationship in the control logic of each logic sheet.

The online monitor support, on the other hand, is achieved by displaying a control state done by a controller having the control program created from the control logic on a control logic in a display screen.

Such control program creation support or online monitor support requires display of the control logic on the display screen. The display is carried out in units of logic sheet. That is, the control logic is displayed in units of logic sheet forming the control logic, and the entire control logic is displayed by sequentially beginning a new page of the logic sheets.

Such logic sheet unit display requires new-page beginning operation. In the prior art, a new-page beginning button system is used for the new-page beginning operation. In this system, more specifically, the logic sheets required by the user are displayed by clicking the new-page beginning button provided on the display screen to put the current mode to a new-page mode and then entering information (generally one of sheet numbers consecutively added to the logic sheets) about one of the logic sheets to be displayed through the new-page beginning operation in a sheet designation information input field.

Techniques relating to the engineering tool are disclosed and known not only in JP-A-2003-67007 but also in JP-A-2001-236118 and JP-A-11-202910.

There still a room for improvement in the handleability of the engineering tool in aforementioned prior art. That is, the prior art engineering tool employs the new-page button system for the new page beginning operation of logic sheets, which requires clicking operation of the new-page button to put the current mode to a new-page mode and also input operation of the sheet designation information. As a result, with respect to the new-page beginning operation, the user has to enter the sheet designation information, with a large user's burden and a bad handleability.

With regard to even reference of the logic sheets, the prior art engineering tool has a poor handleability. For example, during editing of a logic sheet, the user often requires reference of the logic sheets for the purpose of obtaining the description contents of the logic sheets before and after the editing logic sheet or the description contents of the entire control logic. In such a case, the prior art engineering tool requires the user to refer to the logic sheets while troublesomely repeating the new-page beginning operation based on the new-page button system. In practice, in addition, only after the logic sheet is displayed through the new-page beginning operation, the user can know that the displayed logic sheet is a user's reference target. If the displayed logic sheet is a user's reference target, then the user has to repeat the new-page beginning operation until a desired reference target logic sheet appears, which results in a large user's burden.

### SUMMARY OF THE INVENTION

In view of the aforementioned background circumstances, it is a first object of the present invention to provide an engineering tool which can increase a handleability by improving the operability of new-page beginning operation of logic sheets, and it is a second object of the present invention to provide an engineering tool which can increase a handleability by improving the operability of reference of logic sheets.

As mentioned above, in each of the logic sheets in the control logic, a connection relationship between the logic sheets is defined by a connection described on the logic sheet, and the connection has a function of having sheet connection information for defining the connection relationship of the logic sheet. In accordance with the present invention, the first object is attained by paying attention to such a connection function as to define the logic-sheets connection relationship and making the most of the connection function. That is, an operable button function is provided to a connection on a display screen. When the connection is operated as the button function, the logic sheet having defined sheet connection information possessed by the operated connection is used as a new-page candidate, and logic sheet information about the logic sheet of the new-page candidate is displayed on the display screen in the form of a list. As a result, the operability of new page beginning operation of the logic sheet is increased with an improved handleability.

In the engineering tool, more specifically, a control logic is divided into a plurality of logic sheets to be edited, a connection having sheet connection information for defining a connection relationship between the logic sheets is described on the associated logic sheet, and the control logic is displayed on the display screen while the control logic is displayed in units of logic sheet in a new-page beginning manner. An operable button function is provided on the display screen to the connection, so that, when the connection is operated as the button function, the logic sheet defined by the sheet connection information possessed by the operated connection is used as a new-page candidate, and logic sheet information of the new-page candidate is displayed on the display screen in the form of a list.

In the aforementioned engineering tool, the new-page operability can be increased by utilizing the logic sheet information displayed in the form of a list in the operation of displaying a new-page target logic sheet. In this way, the aforementioned engineering tool of the present invention is designed to begin a new page of the logic sheet corresponding to the designated logic sheet information by a user who conducts designating operation for the logic sheet information displayed in the form of a list on the display screen.

The handleability of the aforementioned engineering tool is made high by the user who can at least schematically the description contents of the logic sheets of the new-page candidates in the logic sheet information displayed in the form of a list. In this case, the aforementioned engineering tool of the present invention is designed to display a list of the logic sheet information as a thumbnail of the new-page candidates.

In accordance with the present invention, as in the case of attaining the above first object, the above second object is attained by utilizing the function of the connection. That is, as in the above case, a button operable on a display screen is provided to a connection, so that, when the connection is operated as a button function, the logic sheet having sheet connection information possessed by the operated connection is used as a reference candidate, and the logic sheet of the reference candidate is displayed in a reduced manner so as to be located parallel to the logic sheet currently displayed on the display screen for the purpose of creation of the control logic or the like. As a result, the operability of reference of the logic sheet is increased and a handleability is improved.

In an engineering tool, more specifically, a control logic is divided into a plurality of logic sheets to be edited, a connection having defined sheet connection information for defining a connection relationship between the logic sheets is described on the associated logic sheet, and the control logic is displayed on a display screen in units of logic sheet. A button function operable on the display screen is provided to the connection, so that, when the connection is operated as the button function, the logic sheet having the defined sheet connection information possessed by the operated connection is used as a reference candidate, and the logic sheet of the reference candidate is displayed in a reduced manner so as to be located parallelly to the logic sheet currently displayed on the display screen.

In accordance with the above engineering tool of the present invention, the operability of new-page beginning operation of the logic sheets can be increased with an improved handleability, and the operability of reference of the logic sheets can be increased with an improved handleability.

Other objects, features and advantages of the invention will become apparent from the following description of the embodiments of the invention taken in conjunction with the accompanying drawings.

### BRIEF DESCRIPTION OF THE DRAWINGS

FIG. 1 shows a block diagram of an arrangement of an engineering tool in accordance with an embodiment of the present invention;

FIG. 2 shows an example of a display screen when new-page beginning operation is carried out;

FIG. 3 shows another example of the display screen when new-page beginning operation is carried out; and

FIG. 4 shows an example of the display screen when reference display operation is carried out.

### DESCRIPTION OF THE EMBODIMENTS

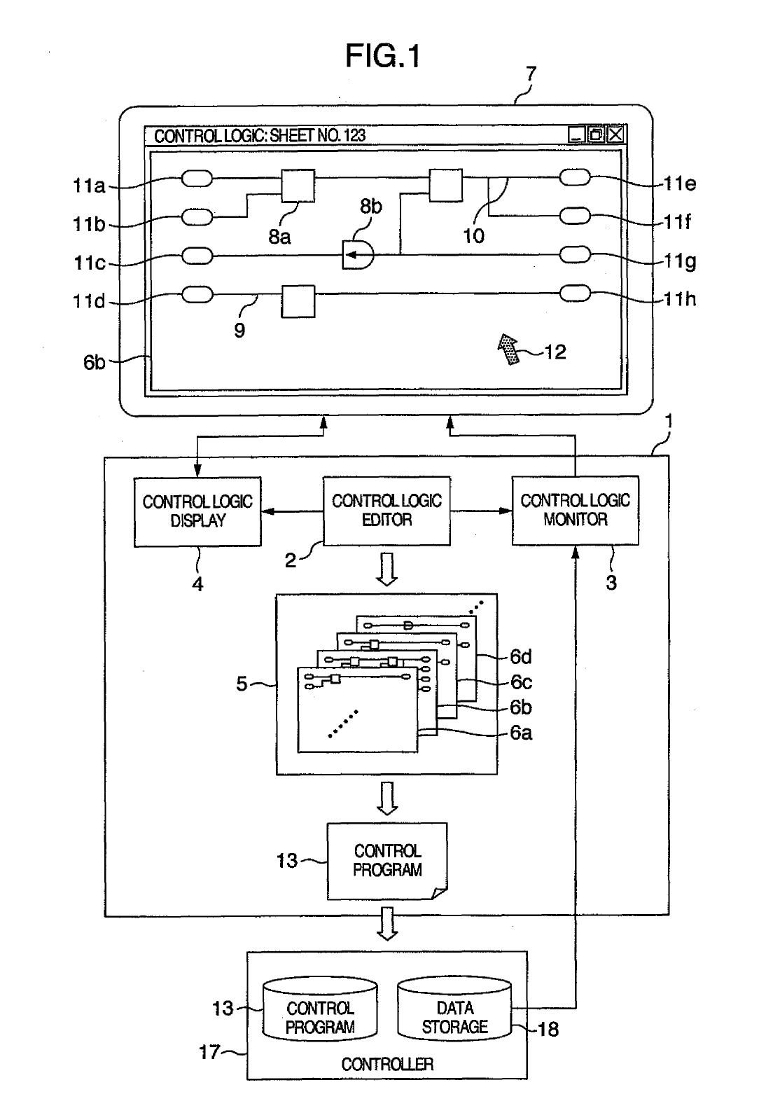

Explanation will be made as to an embodiment of the present invention. FIG. 1 shows a block diagram of a major arrangement of an engineering tool 1 in accordance with an embodiment of the present invention. The engineering tool 1 takes a form of a computer program or of a data processing device having the control program mounted therein. The engineering tool 1 includes a control logic editor 2, a control logic monitor 3, and a control logic display 4.

The control logic editor 2 functions to edit a control logic 5. The control logic 5 is made up of a plurality of logic sheets 6 (6a, 6b, . . . ), and description contents in the control logic 5 are partially described in each of the logic sheets 6. Editing of the control logic 5 is carried out by displaying one of the logic sheets 6 as an editing target in units of the logic sheet 6 on a display screen of a display device 7 and by using various sorts of function macros 8 (8a, 8b, . . . ) such as AND or OR previously prepared as a control logic exclusive language or by using an input line 9 and an output line 10. In this connection, the editing of the control logic is assumed to include modification of an existing control logic and creation of a new control logic.

The logic sheets 6, each of which has a defined connection relationship, are connected with the connection relationship to form the control logic 5. The connection relationship of the logic sheet 6 is defined as a connection. More specifically, connections 11 (11a, 11b, . . . ) are described on the logic sheets 6 to be associated with the input line 9 and the output line 10 of the function macro 8, and each of the connections 11 takes a role of having sheet connection information for defining the connection relationship of each logic sheet 6.

The connection 11 has a button function in addition to a function of having sheet connection information. That is, the connection 11 has a function of setting a new-page mode or a reference display mode for the display of the logic sheet 6 with use of the control logic display 4 as will be mentioned later by clicking the logic sheet 6 displayed in the display screen of the display device 7 with such a pointer device as a mouse having a pointer 12 on the display screen of the display device 7.

The control logic 5 edited by the control logic editor 2 is converted to a control program 13 based on a general language. The control program 13 created through the conversion of the control logic 5 is sent to a controller 17, and is used for control of a plant such as an atomic power plant. The controller 17 is provided therein with a data storage 18 so that an execution result calculated based on the control program 13 is stored in the data storage 18.

The control logic monitor 3 functions to provide a display on the control logic 5 for online monitoring. More specifically, the control logic monitor 3 functions to display the execution result calculated by the controller 17 for the input line 9 and the output line 10 of each function macro 8 on the displayed logic sheet 6 under control of the control program 13.

The control logic display 4 functions to display the control logic 5 on the display device 7. The display of the control logic 5 based on the control logic display 4 is carried out in units of logic sheet. In more detail, the control logic display is carried out in units of each logic sheet 6 forming the control logic 5, and the logic sheets 6 are sequentially displayed through such new-page beginning operation as to update the display target (which will be explained later), thus displaying the entire control logic 5.

The control logic display 4 is designed so as to enable reference display of the logic sheet 6. The reference display means, during editing of, e.g., the logic sheet 6b, to display the other logic sheets 6a, 6d, . . . connected to the logic sheet 6b as references for the purpose of obtain the description contents of the logic sheets after and before the logic sheet 6b and the entire description contents of the control logic 5, and the reference display is carried out with the button function of the connection 11 in such a manner as to be explained later.

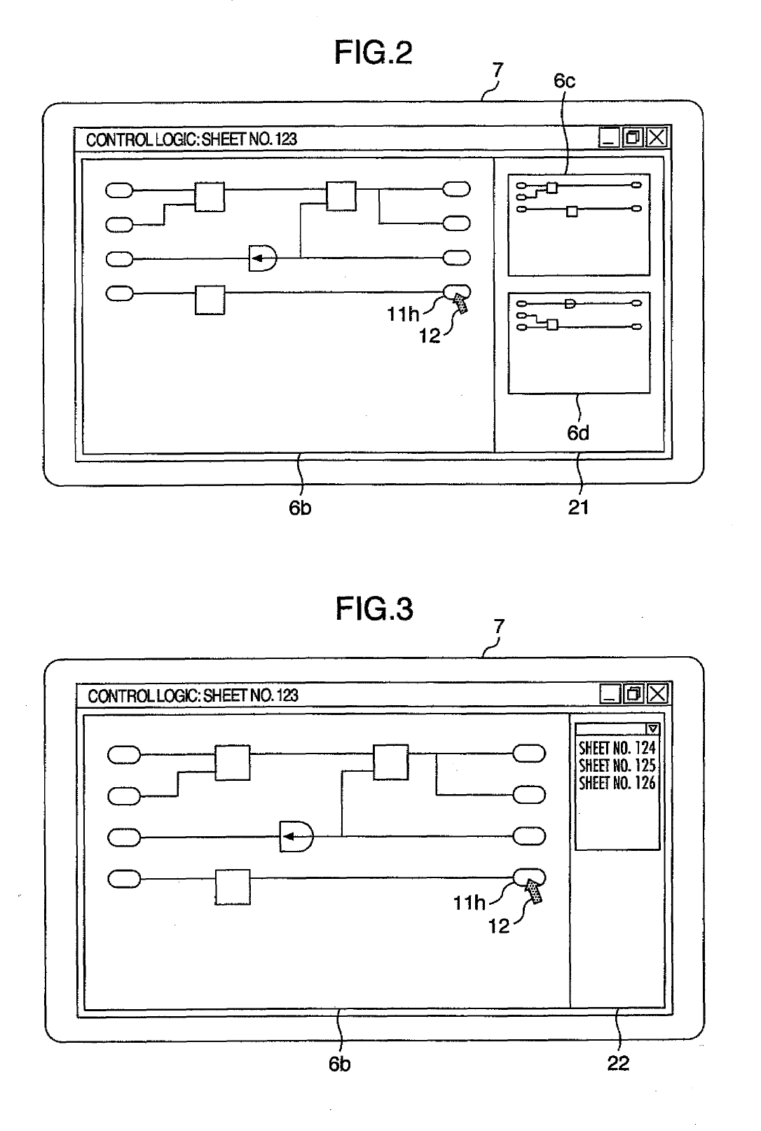

Explanation will next be made as to new-page beginning operation and reference displaying operation for a logic sheet in the engineering tool 1. FIG. 2 shows an example of the display screen of the display device 7 when new-page beginning operation is carried out. With respect to the logic sheet 6b already displayed on the display device 7, when it is desired to change the displayed logic sheet 6b to a new page of a logic sheet having a connection relationship defined, for example, by a connection 11h, the user clicks the connection 11h with the pointer 12. This causes the control logic display 4 to be put in a new-page mode, so that a new-page candidate display field 21 is displayed on the display screen to be parallel to the display of the logic sheet 6b, and a thumbnail list of the logic sheets 6c, 6d, . . . as new-page candidates is displayed in the new-page candidate display field 21. In this case, the clicking operation of the connection 11h is required to be linked to the new-page candidate logic sheets 6c, 6d, . . . This can be achieved by using sheet connection information possessed by the connection 11h.

After the thumbnail list of the new-page candidate logic sheets 6c, 6d, . . . is displayed, the user can determine the logic sheet as a new-page target by confirming the description contents of the new-page candidate in the displayed thumbnail list. After the logic sheet 6c as the new-page target is determined in this manner, the user designates the logic sheet 6c with the pointer 12, which results in that the logic sheet 6b is changed to the logic sheet 6c as a new page.

FIG. 3 shows another example of the display screen after new-page beginning operation is carried out. In this example, a new-page candidate display field 22 appears in the new-page mode. A list of sheet numbers of the new-page candidate logic sheets is displayed in the new-page candidate display field 22. In this case, new-page beginning operation is carried out by the user who designating desired one of the sheet numbers of the logic sheets as a new-page target with the pointer 12 or the like.

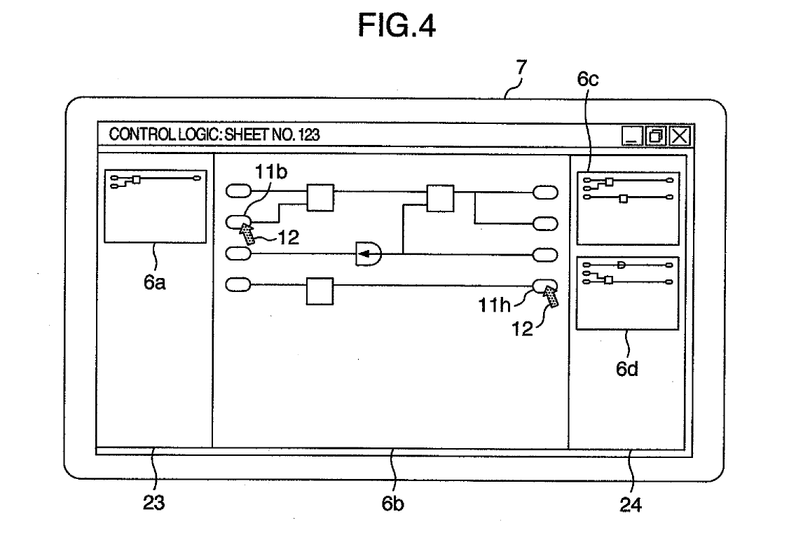

FIG. 4 shows an example of the display screen after reference displaying operation is carried out. With respect to the logic sheet 6b being displayed on the display device 7, it is desired to refer to, for example, the logic sheet having a defined connection relationship with use of a connection 11b provided at its input side and the logic sheet having a defined connection relationship with use of the connection 11h provided at its output side; the user clicks the connection 11b and the connection 11h respectively with the pointer 12 (, which clicking operation being a right click or double click if the clicking operation for the new-page beginning operation is, for example, left click or single click for distinguishing the clicking operation for the connection clicking operation from the clicking operation for the new-page beginning operation). This causes the control logic display 4 to be put in a reference display mode, so that an input-side reference candidate display field 23 and an output-side reference candidate display field 24 are displayed on the display screen so as to be parallel to the display of the logic sheet 6b, and a thumbnail of a logic sheet 6a as a reference candidate and thumbnails of logic sheets 6c, 6d, . . . as reference candidates are displayed in the input-side reference candidate display field 23 and in the output-side reference candidate display field 24 respectively. In this case, the clicking operation of the connection 11b or the connection 11h is required to be linked to the new-page candidate logic sheets 6c, 6d, . . . This can be achieved by using sheet connection information possessed by the connection 11b or the connection 11h.

In this connection, the output of the function macro 8 often becomes an input of a plurality of logic sheets, but the input of the function macro corresponds to only the output of a single logic sheet. For this reason, it is general that a single reference candidate logic sheet is displayed in the input-side reference candidate display field 23, and a plurality of reference candidate logic sheets are displayed in the output-side reference candidate display field 24.

The embodiment of the present invention has been explained above. However, this embodiment is given only as a typical example, and the present invention may be embodied in various ways without departing from the gist or subject matter of the present invention.

1. An engineering tool in which a control logic is divided into a plurality of logic sheets to be edited, a connection having a sheet connection information for defining a connection relationship between the logic sheets is described on the logic sheet, and the control logic is displayed on a display screen so as to begin a new page of the logic sheets of the control logic in units of the logic sheet in the control logic; and
in which a button function operable on the display screen is provided to the connection, and when the connection as the button function is operated, the logic sheet defined by sheet connection information possessed by the operated connection is used as a new-page candidate, and the logic sheet information of the new-page candidate is displayed on the display screen in the form of a list.

2. An engineering tool according to claim 1, wherein, when a user designates the logic sheet information displayed in the form of a list on the display screen, a new page begins to one of the logic sheets corresponding to the designated logic sheet information.

3. An engineering tool according to claim 1, wherein the list display of the logic sheet information is carried out as a thumbnail list of the logic sheets as the new-page candidates.

4. An engineering tool according to claim 2, wherein the list display of the logic sheet information is carried out as a thumbnail list of the logic sheets as the new-page candidates.

5. An engineering tool in which a control logic is divided into a plurality of logic sheets to be edited, a connection having sheet connection information for defining a connection relationship between the logic sheets is described on the logic sheet, the control logic is displayed on a display screen so as to begin a new page of the logic sheets of the control logic in units of the logic sheet in the control logic; and
in which a button function operable on the display screen is provided to the connection, and when the connection is operated as the button function, one of the logic sheets defined by the sheet connection information possessed by the operated connection is used as a reference candidate, and the logic sheets of the reference candidates are displayed on a reduced scale to be parallel to the logic sheet currently being displayed on the display screen.
